(19) United States
(12) Patent Application Publication
(10) Pub. No.: US 2011/0254838 A1
(43) Pub. Date: Oct. 20, 2011

(54) METHOD FOR TRANSMITTING DATA ON STEREOSCOPIC IMAGE, METHOD FOR PLAYING BACK STEREOSCOPIC IMAGE, AND METHOD FOR CREATING FILE OF STEREOSCOPIC IMAGE

(75) Inventors: Kugjin Yun, Daejon (KR); Hyun Lee, Daejon (KR); Gwangsoon Lee, Daejon (KR); Bongho Lee, Daejon (KR); Namho Hur, Daejon (KR); Jinwoong Kim, Daejon (KR); Soo-In Lee, Daejon (KR)

(73) Assignee: Electronics and Telecommunications Research Institute, Daejon (KR)

(21) Appl. No.: 13/141,574

(22) PCT Filed: Jun. 24, 2009
(86) PCT No.: PCT/KR2009/003416

§ 371 Date: Jun. 22, 2011

(30) Foreign Application Priority Data
Dec. 22, 2008 (KR) 10-2008-0131258

(51) Int. Cl. G06T 15/00; G06K 9/00

(52) U.S. Cl. 345/419; 382/154

(57) ABSTRACT

Provided are a method for transmitting data related to a stereoscopic image and a method for playing back a stereoscopic image. The stereoscopic image data transmitting method includes generating stereoscopic image data related to a stereoscopic still image in a predetermined file format (200), and transmitting the generated data. The file format (200) includes a media information unit (220) including the stereoscopic still image (222), control information (212) for controlling playing back the stereoscopic still image, and image composition information (214) indicating a type of composing a stereoscopic image using the stereoscopic still image.

### TECHNICAL FIELD

The present invention relates to a stereoscopic image; and, more particularly, to a method for transmitting data related to a stereoscopic image and a method for playing back a stereoscopic image.

### BACKGROUND ART

Lately, a technology of providing a three-dimensional (3D) image using a stereoscopic image was introduced. A 3D display device is used to playback a stereoscopic image to give perspective and realism. The 3D display device displays different 2D images to each of viewer's eyes or alternately displays different 2D images to display a stereoscopic image.

A typical stereoscopic image service has been focused on providing a simple stereoscopic still image or a stereoscopic video. The simple stereoscopic still image is an image played back in 3D, for example, a 3D picture and a 3D slide. The stereoscopic video is a plurality of connected stereoscopic frames that are played back in three dimensions.

In order to express motion in an image through the stereoscopic video, the desired motion must be recorded in all of the stereoscopic frames. Therefore, the stereoscopic video disadvantageously includes a large amount of data. Due to the disadvantage, it is required to develop a technology of expressing various scenes with less data amount through a stereoscopic image.

### DISCLOSURE OF INVENTION

### Technical Problem

An embodiment of the present invention is directed to providing a method for providing a stereoscopic image that expresses various scenes using a stereoscopic still image.

Another embodiment of the present invention is directed to providing a method of minimizing a data amount required to transmit or playback a stereoscopic image.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method of transmitting stereoscopic image data including generating stereoscopic image data related to a stereoscopic still image in a predetermined file format, and transmitting the generated data, wherein the file format includes a media information unit including the stereoscopic still image, control information for controlling playing back the stereoscopic still image, and image composition information indicating a type of composing a stereoscopic image using the stereoscopic still image.

In accordance with another aspect of the present invention, there is provided a method of playing back a stereoscopic image including receiving data generated in a file format including a media information unit having a stereoscopic still image and image composition information and control information, composing a stereoscopic image from the stereoscopic still image according to the image composition information, and playing back the stereoscopic image according to the control information.

In accordance with another aspect of the present invention, there is provided a method of generating a file of stereoscopic image data, including generating a media information unit including a stereoscopic still image, generating a header information unit including control information for controlling the stereoscopic still image and image composition information for indicating a type of composing a stereoscopic image using the stereoscopic still image, and generating a file format including the media information unit and the header information unit.

### Advantageous Effects

A method for transmitting data related to a stereoscopic image and a method for playing back a stereoscopic image according to the present invention can provide a stereoscopic image that expresses various scenes using a stereoscopic still image.

A method for transmitting data related to a stereoscopic image and a method for playing back a stereoscopic image according to the present invention can minimize a data amount for transmitting and playing back a stereoscopic image.

### BRIEF DESCRIPTION OF DRAWINGS

FIG. 1 is a flowchart describing a method of transmitting stereoscopic image data in accordance with an embodiment of the present invention.

FIG. 2 illustrates a file format 200 in accordance with an embodiment of the present invention.

FIG. 3 illustrates a file format 300 in accordance with another embodiment of the present invention.

FIG. 4 is a flowchart describing a method of playing back a stereoscopic image in accordance with an embodiment of the present invention.

FIG. 5 illustrates a file format 500 for providing a 2D image according to the prior art.

FIG. 6 illustrates a file format 600 in accordance with an embodiment of the present invention.

FIG. 7 illustrates a file format 700 in accordance with an embodiment of the present invention.

FIG. 8 illustrates a file format 800 in accordance with an embodiment of the present invention.

FIGS. 9 and 10 are diagrams for describing playing back a stereoscopic image in accordance with an embodiment of the present invention.

FIG. 11 is a diagram illustrating a file format 1000 in accordance with an embodiment of the present invention.

### BEST MODE FOR CARRYING OUT THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like.

To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

The present invention relates to providing a stereoscopic image using a file format having a media information unit and a header information unit. The media information unit includes a stereoscopic still image.

The stereoscopic still image may be used to express various scenes of a stereoscopic image. For example, when the stereoscopic still image is played back with a 2D video associated. For example, in case of playing back a stereoscopic still image with 2D video associated, it is possible to playback only particular objects expressed by a stereoscopic still image in three dimensions. Also, it is possible to playback objects in three dimensions at one scene using a plurality of stereoscopic still images.

Therefore, it is possible to compose more various scenes using a video or audio associated stereoscopic still image than composing scenes using a stereoscopic video or a simple stereoscopic still image. It is also possible to maximize effect of a related scene by playing back a stereoscopic still image with a predetermined scene synchronized. A stereoscopic image can be provided with a small amount of data because a stereoscopic still image includes data related to objects to express in three dimensions only. Also, visual fatigue can be reduced when a user watches a stereoscopic image.

In an embodiment of the present invention, various scenes may be composed through control information for controlling playing back a stereoscopic still image and image composition information about a form of composing a stereoscopic image using stereoscopic still images.

<Method for Transmitting Stereoscopic Image Data>

Hereinafter, a method of transmitting stereoscopic image data in accordance with an embodiment of the present invention will be described.

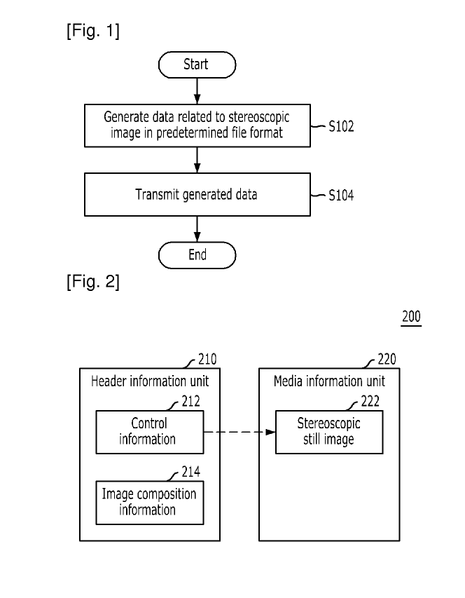

FIG. 1 is a flowchart describing a method of transmitting stereoscopic image data in accordance with an embodiment of the present invention. Referring to FIG. 1, the method of transmitting stereoscopic image data according to the present embodiment includes generating data related to a stereoscopic still image in a predetermined file format at step S102 and transmitting the generated data in the predetermined file format at step S104.

In the present embodiment, the stereoscopic still image includes a still image that is composed in one frame such as Joint Photographic expert Group (JPEG) and Portable Network Graphics (PNG) and a still image that provides an animation effect in one file such as Multiple-Image Network Graphics (MNG). Meanwhile, the stereoscopic image includes an image that can be displayed in three dimensions.

Herein, a file format will be described with reference to FIG. 2. FIG. 2 is a diagram illustrating a file format 200 in accordance with an embodiment of the present invention.

The file format 200 includes a media information unit 220 and a header information unit 210. The media information unit 220 includes a stereoscopic still image 222, and the header information unit 210 includes control information 212 for controlling playing back the stereoscopic still image 222 and image composition information 214 for indicating a stereoscopic image composition type and a file type.

Herein, the stereoscopic image composition type denotes a type of composing a stereoscopic image using a stereoscopic still image. There are various types of composing a stereoscopic image using a stereoscopic still image, which are indicated by the image composition information 214. In general, the stereoscopic image is formed of two stereoscopic still images, which include a left image and a right image. The stereoscopic image composition type may differ according to how the left and right images are combined.

For example, the stereoscopic image composition type includes a frame sequential type that denotes a stereoscopic image composed by alternately and repeatedly playing back frames of a left image and a right image, a field sequential type that denotes a stereoscopic image composed by alternately and repeatedly playing back field images of a left image and a right image, and an interleaving type that denotes a stereoscopic image composed by playing back stereoscopic still images by interleaving an odd number line of a left image and an even number line of a right image by line unit.

The locations of the information unit and the information in the file format 200 may vary according to an embodiment. For example, the image composition information 214 may be included in the control information 212 unlike FIG. 2.

The file format 200 may include image type information indicating a file type for providing a stereoscopic image. The image type information is used to identify information indicating a type of a stereoscopic image stored in a file format. For example, the image type information may be of a stereoscopic still image service and a video/audio associated stereoscopic still image service. The video/audio associated stereoscopic still image service denotes a service providing a stereoscopic image that expresses various scenes using a stereoscopic still image. The video/audio associated stereoscopic still image service can express various scenes by linking a stereoscopic still image with video or audio. The stereoscopic still image service is a service that provides a stereoscopic image simply using a stereoscopic still image without video or audio linked.

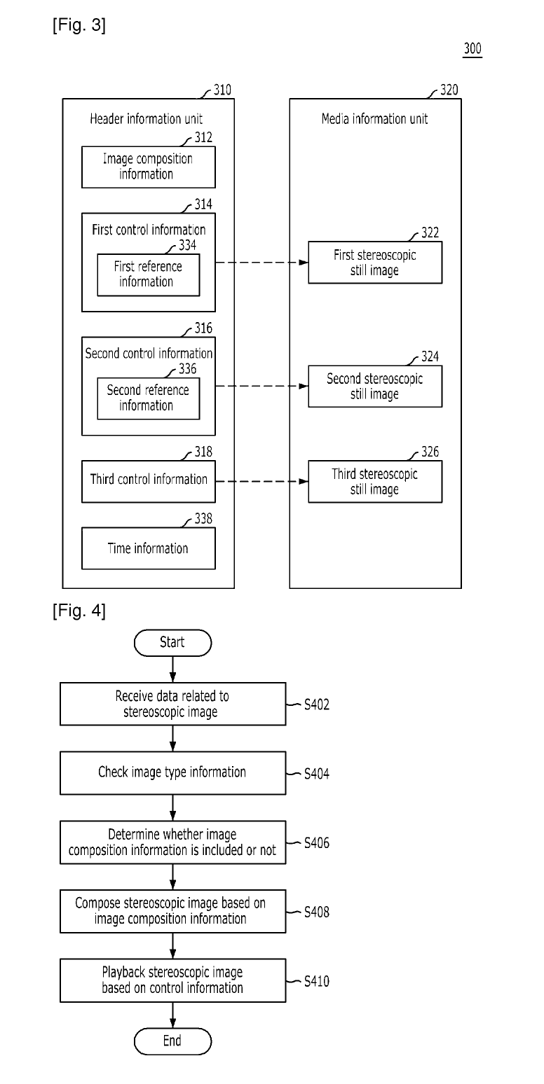

Referring to FIG. 3, a file format according to another embodiment of the present invention will be described. FIG. 3 illustrates a file format 300 in accordance with another embodiment of the present invention.

The file format 300 includes a header information unit 310 and a media information unit 320. As shown in FIG. 3, the media information unit 320 may include a plurality of stereoscopic still images that compose one scene of a stereoscopic image. The plurality of stereoscopic still images may be more than two stereoscopic still images. FIG. 3 shows a file format for three stereoscopic still images.

In other words, the media information unit 320 of the file format 300 includes a first stereoscopic still image 322, a second stereoscopic still image 324, and a third stereoscopic still image 326. In this case, the image composition information 312 included in the header information unit 310 may commonly indicate the stereoscopic image composition types of the first, second, and third stereoscopic still images 322, 324, and 326. It is not necessary to provide image composition information independently for each of the first, second, and third stereoscopic still images if the first, second, and third stereoscopic still images 322, 324, and 326 have the same stereoscopic image composition type. Also, each of the stereoscopic still images may have different image composition information.

The header information unit 310 includes control information 314, 316, and 318 for controlling playing back each of the stereoscopic still images 322, 324, and 326. Each of the control information 314, 316, and 318 may include identification information for each of the control information 314, 316, and 318. The header information unit 310 may include a list of identification information. The list of identification information may be used as information for identifying each control information.

For example, if the list of identification information only includes control information for a stereoscopic still image used in the video/audio associated stereoscopic still image service, it is possible to identify a stereoscopic still image for the video/audio associated stereoscopic still image service by inquiring the list of the identification information.

Meanwhile, if a stereoscopic image is formed of a main image and a supplementary image, two stereoscopic still images must be recognized as one object. Therefore, the control information may include reference information that indicates whether a stereoscopic still image is a main image or a supplementary image.

Referring to FIG. 3, the first control information 314 includes first reference information 334, and the second control information 316 includes second reference information 336. For example, the first reference information 334 indicates whether the first stereoscopic still image 322 is a main image or a supplementary image. The second reference information 324 indicates whether the second stereoscopic still image 324 is a main image or a supplementary image.

For example, in case of using the first stereoscopic still image 322 as a main image and using the second stereoscopic still image 324 as a supplementary image, the stereoscopic image is played back in three dimensions by combining the two stereoscopic still images 322 and 324. Herein, the first reference information 334 includes information that the first stereoscopic still image 322 is used as the main image, and the second reference information 336 includes information that the second stereoscopic still image 324 is used as the supplementary image.

Also, the first reference information 334 and the second reference information 336 may include identification information that indicates which stereoscopic still image is connected to. Meanwhile, if a stereoscopic still image is used as the video/audio associated stereoscopic still image service, it needs time information that indicates a reproduction start time and a reproduction end time. Such time information may be included in a header information unit.

Referring to FIG. 3, in case of composing a stereoscopic image by playing back the third stereoscopic still image 326 with a 2D video associated, the third stereoscopic still image 326 may be played back in a predetermined period of a 3D video. For this, the time information 338 includes information about a reproduction start time and a reproduction end time of the third stereoscopic still image 326. The third control information 318 may be formed to control playing back the third stereoscopic still image 326 according to the time information 338.

Meanwhile, the header information unit may include information about a method of displaying a stereoscopic still image in three dimensions. Various 3D display methods can be used to display a stereoscopic still image in three dimensions. For example, the 3D display methods include a parallax barrier method, a lenticular method, and a polarization method.

<Method of Playing Back Stereoscopic Image>

Hereinafter, a method of playing back a stereoscopic image according to an embodiment of the present invention will be described.

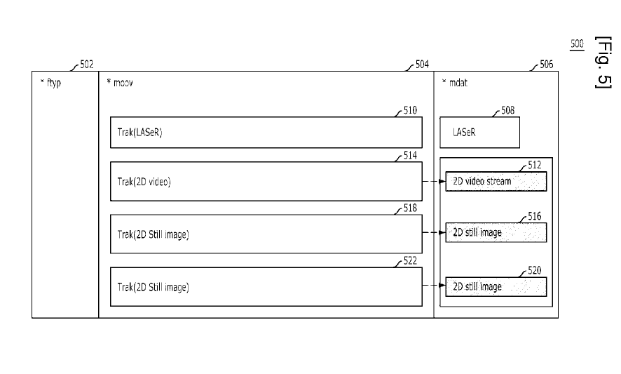

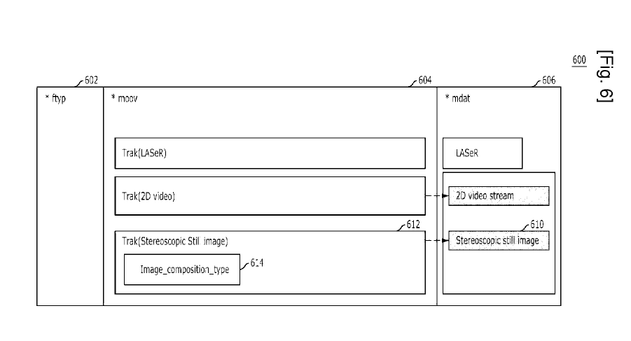

FIG. 4 is a flowchart illustrating a method of playing back a stereoscopic image in accordance with an embodiment of the present invention. Referring to FIG. 4, the method includes receiving data related to a stereoscopic image at step S402, composing a stereoscopic image according to image composition information at step S408, and playing back a stereoscopic image according to control information at step S410.

The data related to the stereoscopic image is generated in a file format including a media information unit and a header information unit. The media information unit includes a stereoscopic still image, and the header information unit includes control information and image composition information.

According to an embodiment, the image composition information may be included in control information.

Also, the image composition information may be image composition information for a plurality of stereoscopic still images that compose one scene of a stereoscopic image. It prevents repetition of same image composition information when the plurality of stereoscopic still images compose a stereoscopic image through the same stereoscopic image composition type.

As shown in FIG. 4, the method of playing back a stereoscopic image according to the present embodiment may further include checking image type information that indicates a type of providing a stereoscopic image and a file type. By determining the image type information, a method of playing back a stereoscopic image can be selected. For example, if the image type information is determined as a video/audio associated stereoscopic still image service at step S404, the steps S408 and S410 are performed.

As shown in FIG. 4, the method of playing back a stereoscopic image may further include determining whether image composition information is included or not at step S406. The image type information is included in the header information unit as information related to a stereoscopic still image that composes a stereoscopic image.

In case of a monoscopic still image, the image type information may be not included.

Therefore, it is possible to determine whether a still image is a stereoscopic still image or not by determining whether the image composition information is included or not at step S406. For example, if it is determined that the image composition information is included as step S406, the steps S408 and S410 are performed.

Although it is not shown in FIG. 4, the method of playing back a stereoscopic image may further include inquiring identification information of control information from a list of identification information included in the header information unit. The identification information list includes identification information of control information proper to a predetermined reference. For example, the list of identification information may include only control information about a stereoscopic still image used for the video/audio associated stereoscopic still image service. In this case, it is possible to determine whether a stereoscopic still image is used for the video/audio associated stereoscopic still image service by inquiring the identification information.

The step S408 of composing a stereoscopic image may include checking reference information that indicates whether a stereoscopic still image is a main image or a supplementary image. The stereoscopic image may be formed in combination of the main image and the supplementary image. It is possible to determine whether the stereoscopic still image is the main image or the supplementary image.

The step S410 of playing back a stereoscopic image may include checking information about a display scheme of displaying a stereoscopic still image in three dimensions. It is because the stereoscopic still image can be played back in three dimensions through various methods.

The step S408 of composing a stereoscopic image may include linking 2D video or audio with a stereoscopic still image. The video/audio associated stereoscopic still image service enables composing various scenes by playing back the stereoscopic still image with video or audio linked. The video/audio associated stereoscopic still image service may be provided through linking 2D video or audio with the stereoscopic still image.

Since other details of the method of playing back a stereoscopic image are identical to those of the method of transmitting stereoscopic image data, detail description thereof is omitted.

### Embodiments

Hereinafter, a file format for transmitting a stereoscopic image or for playing back a stereoscopic image according to an embodiment of the present invention will be described.

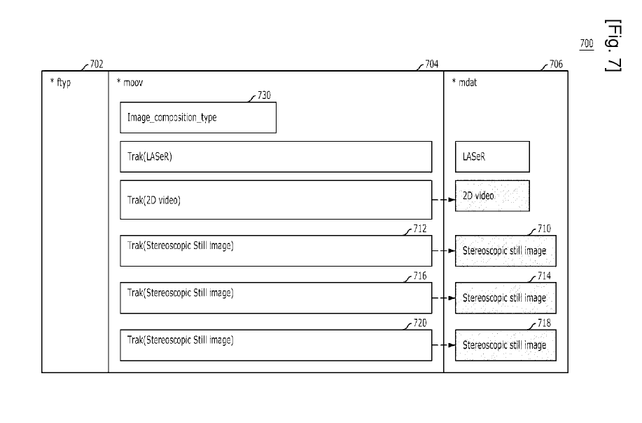

The file format according to the present embodiment is compatible with typical file formats. Therefore, a typical file format according to the prior art will be described at first with reference to FIG. 5. FIG. 5 is a diagram illustrating a file format 500 for providing a 2D image according to the prior art.

The file format 500 includes a ftyp block 502, a moov block 504, and a mdat block 506. The ftyp block 502 includes information indicating a file type stored in the file format 500. The moov block 504 includes control information for playing back a media stream stored in the file format. The mdat block 506 includes media stream data.

As shown in FIG. 5, the moov block 504 includes track boxes. Each of the track boxes 510, 514, and 522 includes control information and supplementary information for playing back a media stream. The track box may be included in each media stream or each type of media streams. For example, FIG. 5 shows that each of media streams 508, 512, 516, and 520 in the mdat block 506 include the track boxes 510, 514, 518, and 522. However, 2D still images 516 and 520 have one track block because the 2D still images 516 and 520 are the same type of the media stream.

Referring to FIG. 2, the mdat block 506 includes a Lightweight Application ScenE Representation (LASeR) 508, a 2D video stream 512, a 2D still image 516, a 2D still image 520. The LASeR 508 is a scene descriptor. The LASeR 508 includes information about a location and a reproduction time for playing back each of media streams. The LASeR 508 is only an example of a scene descriptor. Any other type of scene descriptor may be used.

The 2D video stream 512 is a media stream for a 2D video and the 2D still images 516 and 520 are media streams for a 2D still image.

Since the file format 500 according to the prior art is designed for a 2D image service as shown in FIG. 5, the file format 500 according to the prior art has limitation to provide a stereoscopic image service for composing various scenes.

FIG. 6 illustrates a file format 600 in accordance with an embodiment of the present invention. As shown in FIG. 6, the file format 600 according to the present embodiment is designed to provide a stereoscopic image.

The file format 600 according to the present embodiment includes a ftyp block 602, a moov block 604, and a mdat block 606. The ftyp block 602 may include information about a service type for providing a stereoscopic image. The ftyp block 602 may be used to identify a type of a stereoscopic image. Table 1 shows information included in the ftyp block 602.

TABLE 1

| | |
|---|---|
| 0 | Reserved |
| 1 | video/audio associated stereoscopic still image service |
| 2 | stereoscopic still image service |

Since a stereoscopic still image is additionally played back by being linked with a main image, the video/audio associated stereoscopic still image service provides a stereoscopic image. The video/audio associated stereoscopic still image service can compose various scenes by controlling a stereoscopic still image. A scene descriptor may be used for the video/audio associated stereoscopic still image service.

The stereoscopic still image service is a service similar to a slide show that provides stereoscopic still images without video or audio linked.

The mdat block 606 includes a stereoscopic still image 610 and the moov block 604 includes a track 612 for a stereoscopic still image. As shown in FIG. 6, the track 612 may include Image_composition_type 613 which is image composition information. However, Image_composition_type 614 may be included in the moov block 604 independently from the track 612 in another embodiment. Further, Image_composition_type 614 may be not included in a box. Image_composition_type 614 may be recorded in a Reserved bit.

Image_composition_type 614 is information about a type of a stereoscopic still image 610 and may include information about a type of a stored stereoscopic still image 610. Table 2 shows a type of a stereoscopic still image indicted by Image_composition_type 614.

TABLE 2

| | |
|---|---|
| 0 | Reserved |
| 1 | Side-by-side |
| 2 | Top-down |
| 3 | Field sequential |
| 4 | Frame sequential |
| 5 | Vertical line interleaved |
| 6 | Horizontal line interleaved |
| 7 | Left-right view (two images) |
| 8 | Reserved for other stereoscopic still image type |

In general, a stereoscopic image is formed by combining two stereoscopic still images, a left image and a right image. Herein, a type of combining a left image and a right image may be recorded in Image_composition_type 614.

The ‘Side-by-side’ type denotes a composition type of a stereoscopic image that is composed by storing a left image at a left half of the stereoscopic still image and a right image at a right half of the stereoscopic still image. The ‘Top-down’ type denotes a composition type of a stereoscopic image composed by storing a left image at a top half of the stereoscopic still image and a right image at a bottom half of the stereoscopic still image.

The ‘Field sequential’ type is a composition type of a stereoscopic image composed by alternately storing a left image and a right image at each field of a stereoscopic still image. The ‘Frame sequential’ type is a composition type of a stereoscopic image composed by alternately storing a left image and a right image at each frame of a stereoscopic still image.

The ‘Vertical line interleaved’ type is a composition type of a stereoscopic image composed by alternately and repeatedly storing a left image and a right image at each of vertical lines of a stereoscopic still image. The ‘Horizontal line interleaved’ type is a composition type of a stereoscopic image composed by alternately and repeatedly storing a left image and a right image at each of horizontal lines of a stereoscopic still image. The ‘Left-right view’ type is a composition type of a stereoscopic image composed by storing a left image and a right image at different stereoscopic still images.

The types of ‘Side-by-side,’ ‘Top-down,’ ‘Field sequential,’ ‘Frame sequential,’ ‘Vertical line interleaved,’ and ‘Horizontal line interleaved’ have one encoded stream and one track for playing back a stereoscopic still image. In case of a service configured of an encoded stream and a track for a stereoscopic still image that expresses one object as described above, a corresponding track may include image composition information.

The ‘Left-right view’ type has two encoded streams formed of a left image and a right image and two tracks for playing back a stereoscopic still image. In case of a service formed of two or more encoded streams and tracks for a stereoscopic still image that expresses one object as described above, the image composition information may not be included in all of tracks. For example, in case of forming a stereoscopic image by combining a 2D video stream as a main image and a stereoscopic still image as a supplementary image, the image composition information may be included only in a track for a stereoscopic still image.

In case of a video/audio associated stereoscopic sill image service, a plurality of stereoscopic still images may compose one scene of a stereoscopic image. For example, a stereoscopic image may be played back using a 2D video as a main image and a plurality of stereoscopic still images as supplementary images. Herein, the plurality of stereoscopic still images can playback different objects in three dimensions.

If the file format includes a plurality of stereoscopic still images and if the plurality of stereoscopic still images have the same information composition information, the image composition information may be included at an upper level of a track without included in each of tracks.

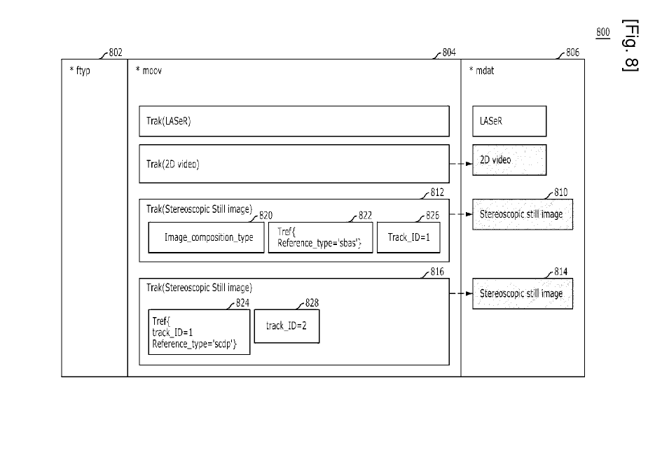

FIG. 7 is a diagram illustrating a file format 700 in accordance with another embodiment of the present invention. Referring to FIG. 7, the file format 700 includes a plurality of stereoscopic still images 710, 714, and 718, and corresponding tracks 712, 716, and 720.

If the same image composition information is applied to the plurality of stereoscopic still images 710, 714, and 718, one image composition information may be commonly used for the plurality of stereoscopic still images 710, 714, and 718 in order to avoid repetition. As shown in FIG. 7, Image_composition_type 730, which is image composition information, is not included in each of stereoscopic still image tracks 712, 716, and 720. The Image_composition_type 730 may be included in an upper level thereof.

If different image composition information are applied to the plurality of stereoscopic still images 710, 714, and 718, corresponding image composition information may be included in each of stereoscopic still image tracks 712, 716, and 720.

Also, a particular scene of 2D video may include a stereoscopic still image and a monoscopic still image together. For example, 2D video of weather forecast may include a monoscopic still image for weather information expressed as a 2D subtitle and a stereoscopic still image of a 3D icon expressing weather. In this case, it is required to determine whether a stream indicated by each track included in a header information unit is a monoscopic still image stream or a stereoscopic still image stream. Two methods for identifying the stream may be considered.

As a first method, the stream is identified by checking whether image composition information is included in a track or not. For example, a stream corresponding to a track including image composition information is determined as a stereoscopic still image stream. Other streams are determined as a monoscopic still image stream.

As a second method, the stream is identified by inquiring a group ID after generating the group ID (Group_ID) by gathering track IDs for stereoscopic still images. For example, a stream having a track ID included in the group ID is determined as a stereoscopic still image stream. Other streams are determined as a monoscopic still image stream.

When a plurality of stereoscopic still images are played back, they must be recognized as one object. For example, if image composition information is ‘Left-right view’, two stereoscopic still image streams of a left image and a right image must be recognized as one object. In this case, although a plurality of physically different tracks for a stereoscopic still image are formed, they must be recognized as one track. If the plurality of tracks are recognized as one track, a plurality of stereoscopic still images can be played back as one stereoscopic image. Therefore, a plurality of stereoscopic still images can be recognized as one object.

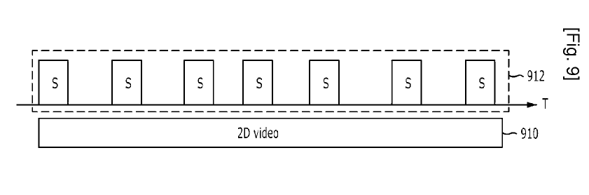

Recognizing a plurality of stereoscopic still images as one object will be described with reference to FIG. 8. FIG. 8 is a diagram illustrating a file format 800 in accordance with another embodiment of the present invention.

The file format 800 includes an ftyp block 802, a moov block 804, and a mdat block 806. The mdat block 806 includes a plurality of stereoscopic still images 810 and 814. The stereoscopic still images 810 and 814 are still images of different view points for expressing the same object. The moov block 804 includes tracks 812 and 816 for stereoscopic still images 810 and 814, respectively.

image_composition_type 820 is commonly applied to the tracks 812 and 816. As shown in FIG. 8, the image_composition_type 820 is included only in the track 812 for avoiding repetition.

Meanwhile, in order to recognize the tracks 812 and 816 as one track, tref 822 and tref 824 include reference information. The reference information may be recorded in reference type included in tref 822 and tref 824 as stereoscopic content base (sbas) and stereoscopic content dependency (scdp). Herein, the ‘sbas’ denotes that a stereoscopic still image related to a track including ‘sbas’ is used as a main image for forming a stereoscopic image. The ‘scdp’ means that a stereoscopic still image related to a track including ‘scdp’ is used as a supplementary image for forming a stereoscopic image.

In FIG. 8, the track 812 includes reference type=‘sbas’ at tref 822 and the track 816 includes reference type=‘scdp’ at tref 828. Therefore, the stereoscopic still image 810 is used as a main image and the stereoscopic still image 814 is used as a supplementary image.

Herein, a track ID may be used for checking connection of a stereoscopic still image 810 and a stereoscopic still image 814. The track ID is unique identification information of each track. In FIG. 8, the track ID 826 of the track 812 is 1, and the track ID 828 of the track 816 is 2. The track 816 may be connected to the track 812 through track_ID information of tref 824. Meanwhile, in case of identifying a stereoscopic still image as a group ID, a group ID may include only track IDs for a main image.

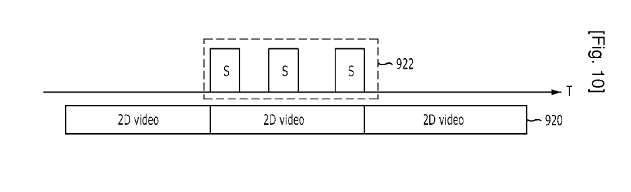

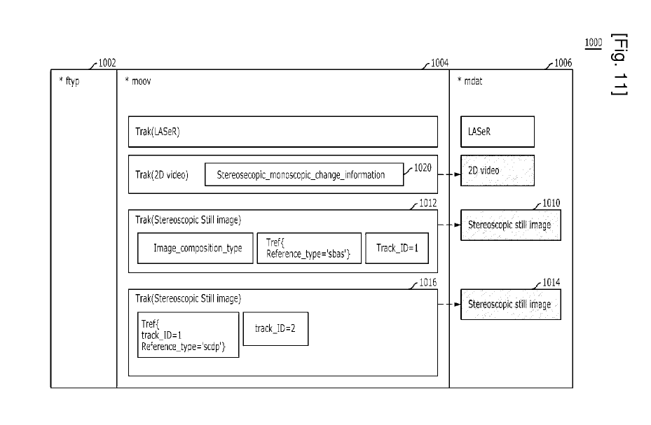

FIGS. 9 and 10 are diagrams for describing reproduction of a stereoscopic image in accordance with an embodiment of the present invention.

In case of the video/audio associated stereoscopic still image service, a service shown in FIGS. 9 and 10 may be provided. In FIGS. 9 and 10, T denotes a reproduction time and S denotes a stereoscopic still image.

In case of a service shown in FIG. 9, a stereoscopic image is composed with a stereoscopic still image 912 linked during an entire time of playing back a 2D video 910. In case of a service shown in FIG. 10, a stereoscopic image is composed with a stereoscopic still image linked for a predetermined partial time of playing back a 2D video 920. In this case, only the 2D video 920 is played back for the remaining time. Therefore, only a 2D image is played back during this period.

In order to provide the service shown in FIG. 10, it requires a reproduction start time and a reproduction end time of a stereoscopic still image 922. For example, a terminal must use a 2D display mode when a 2D image is played back. Also, the terminal must use a 3D display mode when a stereoscopic image is played back. Therefore, the time information may enable the terminal to change a display mode.

A file format including time information will be described with reference to FIG. 10. FIG. 10 is a diagram illustrating a file format 1000 in accordance with an embodiment of the present invention.

Referring to FIG. 10, the file format 1000 may include time information Stereoscopic_Scene_Time_information 1020 at a 2D video track. The time information Stereoscopic_Scene_Time_information 1020 includes a reproduction start time and a reproduction end time of stereoscopic still images 1010 and 1014. The time information 1020 may be included at various positions according to embodiments. For example, the time information 1020 may be included in the moov block 1004 and independently from tracks 1012 and 1016 for a stereoscopic still image.

Table 3 shows a structure of Stereoscopic_Scene_Time_information 1020.

TABLE 3

// stereoscopic_Scene_Time_information
unsigned int(32) stereo_scene_time_count;

for(i=0; i < stereo_scene_time_count; i++) {

If(version==1) {

unsigned int(64) start_time;
unsigned int(64) duration;}

else {//version==0

```
  unsigned int (32) start_time;
  unsigned int(32) duration; }
```

}

‘stereo_scene_time_count’ denotes the time of stereoscopic periods during a reproduction time. ‘start_time’ denotes start times for stereoscopic still images 1010 and 1014. ‘duration’ denotes a time period from starting to ending reproduction of the stereoscopic still images 1010 and 1014.

Meanwhile, it requires 3D display information for effectively playing back a stereoscopic still image in three dimensions. Table 4 shows 3D display information according to an embodiment of the present invention. The 3D display information may be included in a header information unit of a file format as an additional box.

TABLE 4

| | |
|---|---|
| 0 | Reserved |
| 1 | Parallax barrier method |
| 2 | Lenticular method |
| 3 | Polarization method |
| 4 | Reserved for other 3D display |

The above described method according to the present invention can be embodied as a program and stored in a computer-readable recording medium. The computer-readable recording medium is any data storage device that can store data which can be thereafter read by a computer system. The computer readable recording medium includes a read-only memory (ROM), a random-access memory (RAM), a CD-ROM, a floppy disk, a hard disk and a magneto-optical disk.

The present application contains subject matter related to Korean Patent Application No. 10-2008-0131258, filed with the Korean Intellectual Property Office on Dec. 22, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A method of transmitting stereoscopic image data, comprising:
generating stereoscopic image data related to a stereoscopic still image in a predetermined file format; and
transmitting the generated data,
wherein the file format includes a media information unit including the stereoscopic still image, control information for controlling playing back the stereoscopic still image, and image composition information indicating a type of composing a stereoscopic image using the stereoscopic still image.

2. The method of claim 1, wherein the file format includes image type information that indicates a type of providing the stereoscopic image or a file type.

3. The method of claim 1, wherein the control information includes the image composition information.

4. The method of claim 1, wherein the media information unit includes a plurality of stereoscopic still images that compose one scene of the stereoscopic image, and the image composition information indicates a type of composing the stereoscopic image based on the plurality of stereoscopic still images.

5. The method of claim 1, wherein the control information includes identification information about the control information, and the header information unit includes a list of the identification information.

6. The method of claim 1, wherein when the stereoscopic image includes a main image and a supplementary image, the control information includes reference information that indicates whether the stereoscopic still image is the main image or the supplementary image.

7. The method of claim 1, wherein the header information unit includes time information about a playback start time and a playback end time of the stereoscopic still image.

8. The method of claim 1, wherein the header information unit includes information about a method of displaying the stereoscopic still image in three dimensions.

9. A method of playing back a stereoscopic image, comprising:
receiving data generated in a file format including a media information unit having a stereoscopic still image and image composition information and control information;
composing a stereoscopic image from the stereoscopic still image according to the image composition information; and
playing back the stereoscopic image according to the control information.

10. The method of claim 9, further comprising:
checking image type information indicating a type of providing the stereoscopic image or a type of a file.

11. The method of claim 9, wherein the image composition information is included in the control information.

12. The method of claim 9, wherein the image composition information is information about a plurality of stereoscopic still images that compose one scene of the stereoscopic image.

13. The method of claim 9, further comprising:
determining whether the image composition information is included or not.

14. The method of claim 9, further comprising:
inquiring identification information of the control information in an identification information list included in the header information unit.

15. The method of claim 9, wherein said composing a stereoscopic image from the stereoscopic still image includes determining reference information that indicates whether the stereoscopic still image is the main image or the supplementary image.

16. The method of claim 9, wherein said playing back the stereoscopic image includes checking time information about a reproduction start time and a reproduction end time of the stereoscopic still image.

17. The method of claim 9, wherein said playing back the stereoscopic image includes checking information about a method of displaying the stereoscopic still image in three dimensions.

18. The method of claim 9, wherein said composing a stereoscopic image from the stereoscopic still image includes linking a 2D video or an audio with the stereoscopic still image.

19. A method of generating a file of stereoscopic image data, comprising:
generating a media information unit including a stereoscopic still image;
generating a header information unit including control information for controlling the stereoscopic still image and image composition information for indicating a type of composing a stereoscopic image using the stereoscopic still image; and
generating a file format including the media information unit and the header information unit.

20. The method of claim 19, wherein the file format includes image type information that indicates a type of file or a type of providing the stereoscopic image.
